(19) United States
(12) Patent Application Publication
(10) Pub. No.: US 2021/0288542 A1
(43) Pub. Date: Sep. 16, 2021

(54) STATOR FOR AN ELECTRIC MACHINE AND METHOD FOR PRODUCTION OF SUCH A STATOR

(71) Applicant: VOLKSWAGEN AKTIENGESELLSCHAFT, Wolfsburg (DE)

(72) Inventors: Hauke EINFELD, Kassel (DE); Jan WINTER, Kassel (DE); Rainer HELMER, Kassel (DE); Marco BRÜGGEMANN, Kassel (DE)

(73) Assignee: VOLKSWAGEN AKTIENGESELLSCHAFT, Wolfsburg (DE)

(21) Appl. No.: 16/470,879

(22) PCT Filed: Nov. 20, 2017
(86) PCT No.: PCT/EP2017/079747

§ 371 Date: Jun. 18, 2019

(30) Foreign Application Priority Data
Dec. 16, 2016 (DE) 10 2016 225 240.2

(51) Int. Cl. H02K 3/34; H02K 3/28; H02K 3/40; H02K 15/00; H02K 15/02

(52) U.S. Cl. CPC H02K 3/34; H02K 3/28; H02K 15/024; H02K 15/0068; H02K 3/40

(57) ABSTRACT

A stator for an electric machine having slots for receiving conductors used for generating a magnetic field; in the slots, at least two mutually parallel, adjoining conductors being provided, which are electrically insulated from one another by insulation means; the insulations means being formed at least partially by a partition inserted between the conductors. It is an object of the present invention to provide a stator, respectively a method for manufacturing such a stator, which, on the one hand, will make it possible to achieve a high fill factor and, on the other hand, to reliably prevent partial discharges. The objective is achieved by the use and/or characteristics of the partitions being a function of the particular maximum voltage potential between the mutually parallel, adjoining conductors in the slots.

### BACKGROUND INFORMATION

In device circuits of present-day machines, for example, during operation of electric motors driven by clocked inverter sources, there is an increase in recurring high-energy pulses (e.g., switching pulses). They have short rise times and peak voltages well above the nominal value of the supply voltage. These pulses allow insulation systems to age differently than under conventional AC voltage at system frequency. The following points must be thereby taken into consideration: Partial discharges destroy the insulation because of aggressive decomposition products, UV radiation and ozone, and because of electromechanical fatigue caused by the current pulses and because of dielectric heating due to the high-frequency components of the voltage pulses. Superimposed pulses can ignite partial discharges even if the nominal voltage is below the partial-discharge inception voltage. The temperature, air humidity, pulse shape, pulse polarity, and pulse repetition rate thereby substantially influence the degradation rate of the materials. Thus, an adequate spacing from the partial discharge quenching voltage is always essential. This is not only achieved by structural design measures, but also by using sufficiently voltage-resistant, i.e., “thick” insulations. However, this contradicts the requirements for as little as possible insulating material within electric machines. Though only the iron and copper components are electrically active, on the one hand, the available space for the machine to be built is greatly limited in many cases, on the other hand.

Care must be taken in the design and manufacture of electric machines to ensure the smallest possible voltage differences between adjacent conductors in the slots, since, otherwise, partial discharges in the insulating materials of the conductors or between the conductors can occur in response to the voltage load. These partial discharges can damage or destroy the insulation system of the machine over the service life thereof, whereby a failure/breakdown could occur. To prevent partial discharges, the mutual spacing between adjacent conductors can be increased by introducing an additional insulating material.

The German Patent Application DE 10 2004 013 579 A1 discusses using paper films to mutually separate the intersecting lines of the distributed winding in the winding head of the stator, insofar as different phases of a three-phase current are applied thereto. However, if the appropriate conditions are met, it is readily possible that the partial discharge does not take place in the winding head itself, but between the conductors within a slot of the stator.

It has also been discussed to introduce insulating material between all of the conductor elements of the slot. The disadvantage here is a reduced copper fill factor of the stator slots. Furthermore, more material is used than actually needed. The process time required to create the stator is also prolonged.

Another way to prevent partial discharges provides for using an optimized winding scheme where the voltage differences are not so great. However, this entails a more complex manufacturing process. Finally, it is possible that the machine is to be operated at different voltage levels. This is not always possible since the boundary conditions are set in terms of input voltage and output voltage.

### SUMMARY OF THE INVENTION: OBJECT, ACHIEVEMENT THEREOF, ADVANTAGES

The present invention relates, therefore, to a stator in accordance with the definition of the species set forth in claim 1, respectively to a method in accordance with the definition of the species set forth in claim 8. It is an object of the present invention to provide a stator, respectively a method for manufacturing such a stator, which, on the one hand, will make it possible to achieve a high fill factor and, on the other hand, reliably prevent partial discharges.

This objective is achieved by the combination of features set forth in claim 1, respectively by the features of the method set forth in claim 8. Thus, instead of inserting a substantially identically configured partition between all of the lines, this partition is generally optimized and adapted to the particular requirements. The result, therefore, is that only as much material is used for the partition as is expedient for an economical production. While the dielectric strength among the conductors is improved, this hereby increases the fill factor of the respective windings at the same time. Therefore, as described hereinbelow, the present invention basically provides for: analyzing the winding scheme of the machine to determine at which winding locations (between which conductor elements), a voltage difference is too great for the operation of the machine. A properly dimensioned partition is then used at these locations only. Thus, this additional insulating material (partition) is only used at the necessary locations of the winding in order to optimize the amount of material used, as well as the production time, and increase the copper fill factor of the slot. Therefore, the present invention is not primarily effective at the winding heads, but rather in the slots of the stator. The partition may be made of a suitable, commercially available material, whose known insulation values are taken into account when selecting the same.

Further advantages are described in the following: The production time is shortened by the described measures because a partition is not placed overall, in-between every conductor pair, rather only at the needed locations. This reduces the process time and the process risk.

The described measures (partitions) are also beneficial for use without an optimized winding scheme. Additional outlay in the winding makes it possible to reduce the voltage differences, whereby there is no need for further partitions. This is complex elsewhere, however. The measures according to the present invention are advantageous, in particular when clocked inverter sources are used (voltage overshoots during switching). Such sources are found in every vehicle having an electric drive (hybrid/BEV), for example, and are usually constituted of a B6 bridge having an intermediate voltage circuit.

It is, in fact, conceivable to integrate the additional partition inserted between the conductors into the insulation of the conductor itself by locally increasing the insulating layer thereof when necessary. Due to manufacturing economics, however, such measures quickly reach the limits thereof. In accordance with the features set forth in claim 2, the use of standardized, commercially available materials having adapted breakdown strength, such as films, is, therefore, recommended. As surface insulation material, a material of this kind having increased resistance to partial invitations may be made of Nomex 410 paper of the firm Dupont.

In practice, conductors are normally wound up in layers, the layers essentially extending parallel to the lateral surface of the slots. For that reason, relatively substantial potential differences may occur within a winding between conductors that adjoin one another orthogonally to the layer plane. To simplify the manufacture of the stator according to the present invention, the combination of features set forth in claim 3 is recommended in the embodiment of the present invention. The need is eliminated here for adapting the thickness and/or the material characteristics of the partition with regard to each occurring combination of two adjoining conductors on both sides of the partition. Rather, the partition is selected on the basis of the largest (computed) voltage potential between two mutually associated conductors on both sides of the partition. If this largest potential remains below a defined voltage, the need is then eliminated for inserting a partition (film) at least in terms of this particular layer. The voltage potentials of the conductors, which are adjoining in the plane of the partition, are thereby not taken into account since these voltage potentials between the conductors, which are adjacently disposed in the plane of the partition, are likely to be comparatively small.

However, in the event that two or more conductor elements, which are adjacently disposed in the slot, have mutual potential differences, an insulating layer may be optionally placed therebetween by adhesive bonding, for example, prior to introduction of the same into the slot. The conductors, which are to be insulated from one another, are then not disposed on both sides of the plane of the partition, rather in the same plane.

The partitions are advantageously adapted in the thickness thereof to the applied voltage potentials to further optimize the amount of material used and the space requirements in the slot. Thus, a thicker partition is then used for large voltage differences, and a thinner one for smaller voltage differences. In the present invention, the partitions are only used at the relevant locations. The thickness of the partition may be varied.

A further simplification of the manufacturing of the stator according to the present invention is derived from the features set forth in claim 4. The need is eliminated here for removing the partition in those regions where no potential voltages that exceed the partial discharge voltage are computed between the adjoining conductors.

At many locations, generally thicker partitions are used for the windings than theoretically necessary. Thinner insulating materials may, in fact, be obtained from the material manufacturers. However, problems may arise in the processing thereof. Many different material thicknesses in the manufacturing process entail a process risk and increase the costs of the production line.

The features set forth in claim 5 describe a special case for the stator according to the present invention. In accordance therewith, the radially adjoining conductors are possibly separated in each particular case by a partition. More detailed remarks in this regard are provided in the exemplary embodiment set forth below. When necessary, the insulating means are inserted here tangentially between the radially adjoining conductors. The conductors, which are to be mutually separated by the insulating material, are jointly positioned in a plane that extends parallel to the lateral slot wall. Such a combination of features may be especially advantageous when combined with the features set forth in claim 7. The combination of features especially permits the use of very space-saving, narrow slots, allowing a large number of slots to be inserted over the periphery of the stator.

Since the voltage applied to a winding is distributed over the length of the line, voltage differences occur among the conductors (often referred to more precisely as conductor elements of a winding) in accordance with the combination of features set forth in claim 6. Depending on the form of the input voltage, these differences may be considerable. Independently of the type of winding, the stator is preferably designed to be suited for an electric machine.

An embodiment of the present invention that is described in connection with claim 7 is particularly advantageous for the features indicated in connection with claim 5. To produce an improved rotating field, conductors associated with different phases of the input voltage are inserted into the same slot as the two-layer winding. The hereby occurring voltages between adjoining conductors in a slot may thereby differ greatly from one another, so that the present invention may be used very efficiently.

In a further embodiment of the method according to claim 8, the features set forth in claim 10 indicate a method in accordance with which it is possible to determine the thickness of the insulating material to be inserted between two adjoining conductors. It must first be established which partial-discharge inception voltage or partial discharge voltage is to be reached. This voltage must be estimated, and it depends on the boundary conditions of the system being considered. These include the voltage at which the system should be operated, the aging to be expected, environmental influences, and, if an inverter is used, the clocking and frequency thereof. If the partial-discharge inception voltage (for example, 516 V) is specified, then the requisite, total, nominal layer thickness may be determined on the basis of the manufacturer's specifications for the available insulating material. If the last mentioned dimensions are defined (for example, 250 micrometers), it is then possible to determine at this stage to what extent the nominal layer thickness at the particular location must be increased or reduced on the basis of the computed potential between two adjoining conductors. The thickness of the insulation at both conductors is deducted from the thus determined, locally necessary thickness of the insulating material at the two conductors, since, in the insulation coefficient thereof, the insulation corresponds approximately to the insulation coefficient of the material to be additionally inserted.

If the partial-discharge inception voltage and the requisite total nominal layer thickness are established, it is then also possible to determine in the manner described above the partial discharge voltage for two adjoining conductors between which no additional insulating material is inserted. To this end, the thickness of the two insulating layers of the adjoining wires is considered in relation to the entire nominal layer thickness and multiplied by the specified partial-discharge inception voltage.

### BRIEF DESCRIPTION OF THE DRAWING

An exemplary embodiment of the present invention is described in greater detail in the following with reference to the drawing, in which:

FIG. 1 shows a section of a table indicating the computed potentials for the individual conductor elements (in simplified terms, often referred to as conductors) in the respective slot;

FIG. 2 shows a section of a table indicating the potential differences at this stage in each particular case between two conductors in the respective slot in accordance with FIG. 1;

FIG. 3 shows a section of a table illustrating the theoretically necessary insulating layer thicknesses for the potential differences indicated in FIG. 2;

FIG. 4 shows a section of a table in which the insulating layer thicknesses for practical use are recorded in accordance with the results in FIG. 3; and

FIG. 5 shows a section of a table that proposes which commercially available insulating materials could actually be used at which locations on the basis of the results in FIG. 4.

### DETAILED DESCRIPTION

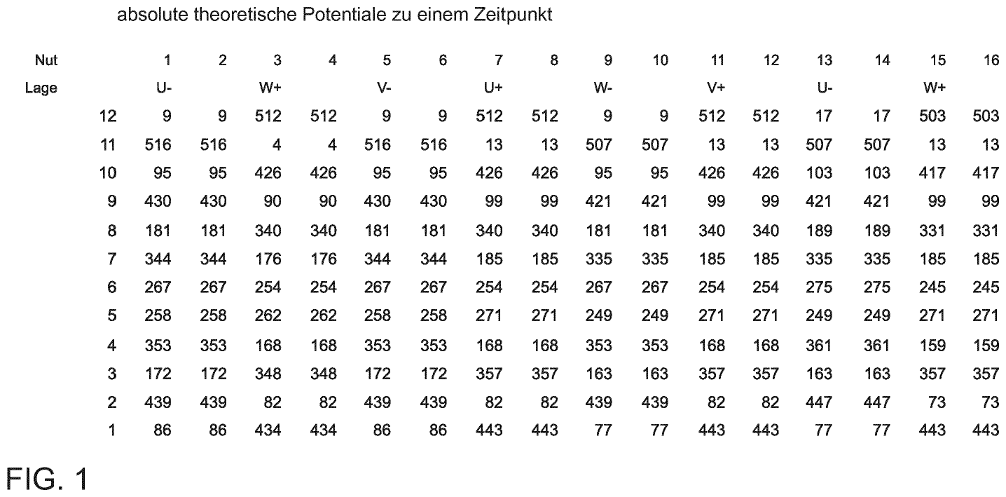

FIG. 1 shows a section of a table in which are entered the computationally determined absolute values of the potentials on the conductors in the individual slots at a specific point in time. The computation method is not described in greater detail here. In the present Application, in each particular case, the designation “conductors” means the sections of a winding that extend within a slot, along the same. In place of “conductors,” “conductor elements” could also be used.

FIG. 1 relates to a stator of a three-phase machine, for which a large amount (for example, 120) slots are provided, into which are inserted the conductors to which phases U, V, W of a three-phase current are applied. The present invention is applicable to all types of windings since the applied voltage drops across the entire line, so that different potentials prevail on the individual conductor elements.

The computations apply to all slots of the stator. In the present example, the stator has 120 slots, but may also have a larger or smaller number of slots. Thus, it is not a concentrated winding (“single-tooth winding”), but a distributed winding. The method may also be generally used for concentrated windings.

The winding of the stator in accordance with FIG. 1, which is provided for a three-phase synchronous motor, has a distinctive feature. In each of the slots, 12 conductors are stacked radially and in a plane that extends parallel to the lateral wall of the slot. Thus, within a slot, only a certain number of conductors are disposed in a stacked arrangement and not adjacently. Thus, the voltage among the individual conductors acts radially, so that the insulating means are to be inserted transversely thereto, tangentially among the conductors. Thus, in the present case, it is only conditionally possible to speak about a layer since each layer is composed of only one single conductor, and these hypothetical layers also extend in a tangential plane. Thus, for example, a potential of 86 V prevails on the radially lowermost conductor of slot 1 in “layer 1,” a potential of 516 V on the conductor in “layer 11,” and a potential of 9V in the conductor in “layer 12.” Corresponding values are apparent from the table for further slots 2 through 16.

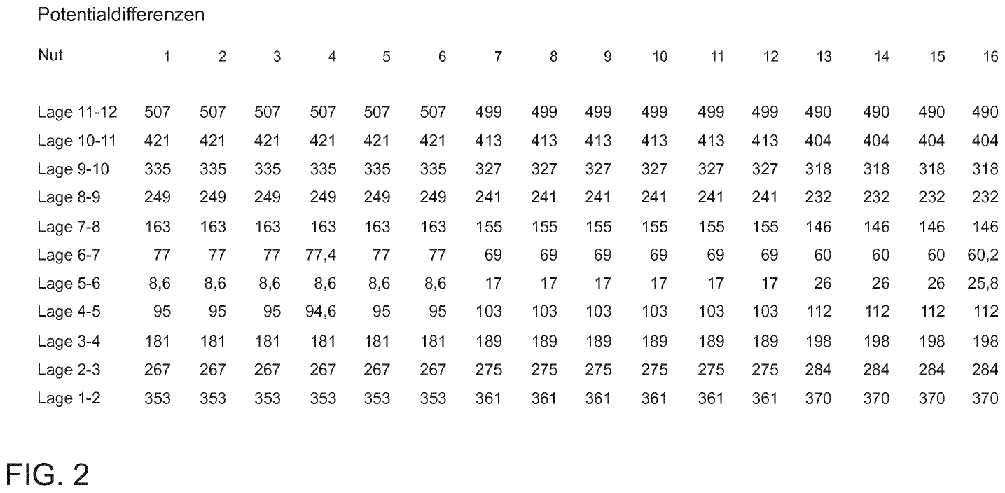

What is important at this stage for a potential partial discharging between two (radially) adjoining conductors, however, is not the absolute potential on the individual conductors, rather the potential difference therebetween. These potential differences are noted in FIG. 2 as the differences between the individual potentials prevailing on the adjacent conductors. FIG. 2 refers to FIG. 1 and has an analogous structure. Thus, when conductor 12 has a potential of 9 V and conductor 11 a potential of 516 V in slot 1, a potential difference of 507 V prevails therebetween. A corresponding value is entered in FIG. 2 for the intermediate space, layer 11-12. The remaining values for slots 1 through 16 and layer-to-layer intermediate spaces for layer 1-2 to layer 11-12 are entered in FIG. 2. Since the insulating layers of two adjoining conductors alone suffice to prevent a partial discharge at a potential difference of 248 V; in terms of additional insulating means, it is only necessary to consider potential differences from FIG. 2 that are greater than 248 V.

The nominal layer thickness is determined from a theoretical consideration, namely which partial-discharge inception voltage (PD) is to be achieved. This value is derived from the boundary conditions of the system (voltage level, aging, environment, inverter clocking, etc.).

If the insulation system is subject to a low voltage load (in the case of stacked conductors having small potential differences), less insulating material leads to the same result. This means that 250 μm layer thickness (wire enamel+partition) is needed in this example to observe the partial discharge voltage at maximum voltage. Depending on the potential difference, a greater or smaller partition thickness is then needed; in many cases, the enamel layer thickness suffices (partition thickness <0).

In the present exemplary embodiment, it is assumed at this stage that the nominal insulating layer thickness between live conductors (including the enamel) should be altogether 250 μm (micrometers). By convention, the nominal layer thickness (wire enamel+partition) of 250 μm assumed in the present case certainly suffices to reliably prevent a partial discharge up until a potential difference of 248 V. Thus, if a considered potential difference is below 248 V, there is no need to insert an additional insulating means or a corresponding film.

It is possible to compute the voltage between two conductors, starting at which a partition is used, for example, from the ratio of the thickness of the enamel layer to the total thickness of the layer, multiplied by the maximum voltage, thus, for example, 2×60 μm/250 μm×516 V˜248 V.

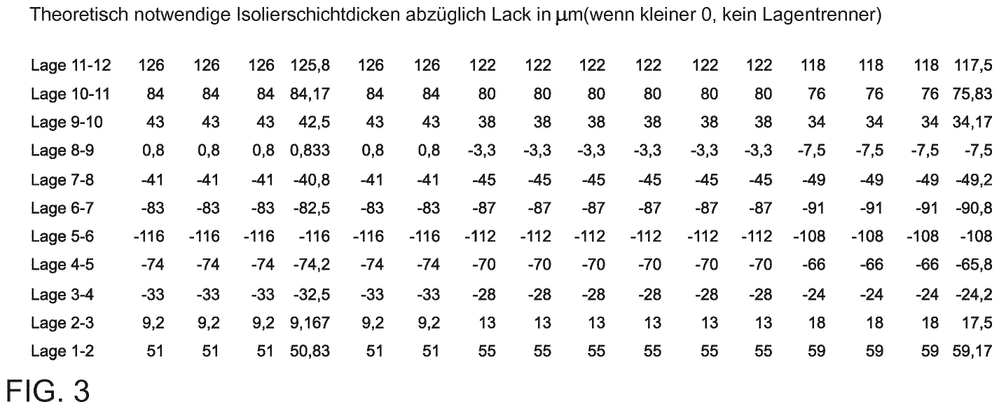

In FIG. 3, it is computed at this stage, at which potential differences derived from FIG. 2, additional insulating means, respectively an appropriate film must be inserted. The assumption is based, for example, on the necessity of providing an insulating layer of a total of 250 μm under the prevailing boundary conditions for a maximum voltage (for example, 516 V). 2×60 μm may then be deducted from this insulating layer, for example, since the insulating layers of the two adjoining conductors already include this amount. Thus, with regard to the theoretically necessary insulating layer thickness, a value of 507 V/516 V×250 μm-2×60 μm˜126 μm is derived for layer 11-12 of slot 1. The further values in the table according to FIG. 3 are computed analogously.

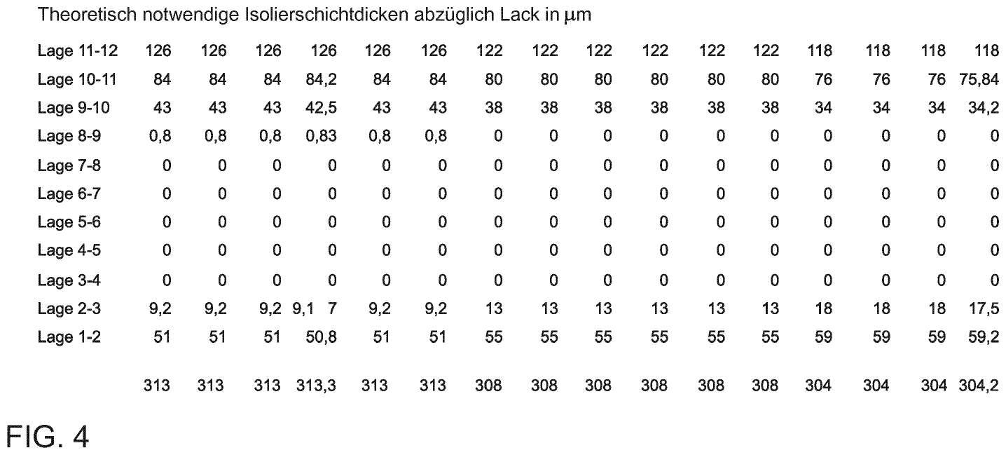

In terms of the use or avoidance of additional insulating means, the computational results derived from FIG. 3 are analyzed at this stage in FIG. 4. If the values computed in accordance with the method described further above in connection with FIG. 3 are positive, it is then necessary to insert an insulating film there having at least the computed thickness, while in the case of negative, computed values, the insulating layers of the two corresponding conductors alone suffice for avoiding a partial discharge. Accordingly, an additional insulating layer having thickness 0 μm is formally noted for the mentioned negative values.

Thus, for all values below 0, the thickness of the enamel layer suffices to reach the requisite partial-discharge inception voltage. For this reason, there is no need to use a partition for additional insulation. All values >0 are rounded up to the next possible material layer thickness (the insulating material is only manufactured in specific layer thicknesses) to ensure that at least the theoretically required layer thickness is reached. In addition, the thickness totals of all of the insulating films used in the particular slot are entered underneath the columns associated with the slots in the table in FIG. 4.

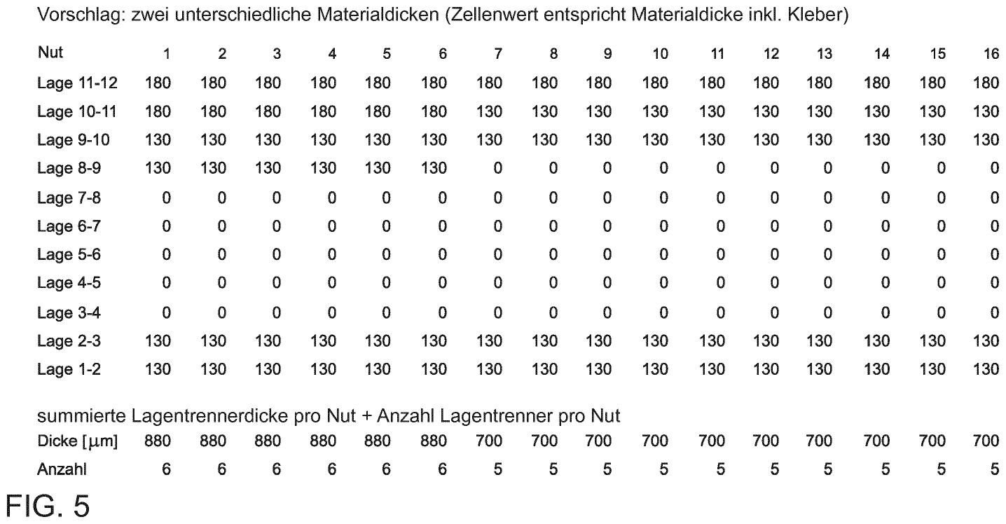

The values in FIG. 5 assume that two standardized insulating films having carrier thicknesses of 80 μm and 130 μm are commercially available, and the thickness of the bonding agent is 50 μm; however, the bonding agent being considered with respect to integrity, namely, in terms of elongation and spacing, but not in terms of the insulation effect. Therefore, a film is used, whose thickness is not smaller than that of the insulating layer computed in connection with FIG. 4. In practical terms, this means that a 130 μm thick film is used for all insulating layer thicknesses computed in accordance with FIG. 4 that are greater than 80 μm and smaller than 130 μm, and a 80 μm thick film is used for insulating layer thicknesses smaller than 80 μm. With regard to the actual thickness of these films, the thickness of the bonding agent is also to be added thereto in each particular case. The material thicknesses of 180 μm, respectively 130 μm indicated in FIG. 5 are thereby arrived at.

For reasons of manufacturing economics, only two film thicknesses are used. To the extent that they are commercially available and reasonably manageable in the manufacturing process, it is self-evident that the films to be inserted may be adapted to the reduced thicknesses computed for layers 9-10 and 8-9.

Also provided in FIG. 5 below the columns associated with the individual slots is the sum of the material thicknesses and the number of partitions to be inserted. The commercially available Nomex 410 film and acrylate bonding agents are indicated exemplarily as the materials used.

1. A stator for an electric machine having:
a plurality of slots for receiving conductors used for generating a magnetic field;
in the slots, at least two mutually parallel, adjoining conductors are provided, which are electrically insulated from one another by insulation means;
wherein the insulations means is formed at least partially by a partition inserted between the conductors, and
wherein the use and/or characteristics of the partitions are/is a function of the particular maximum voltage potential between the mutually parallel, adjoining conductors in the slots.

2. The stator as recited in claim 1, wherein the partitions are preferably made of a special separating film and are always inserted when the maximum voltage potential between the adjoining conductors exceeds a specific value.

3. The stator as recited in claim 1,
wherein a number of adjoining conductors in a slot is configured in at least two stacked layers; and
wherein the use and/or characteristics of the partitions are/is determined by the greatest maximum potential difference of two adjoining conductors.

4. The stator as recited in claim 3, wherein the separating film optionally inserted between the layers extends over at least the two layers.

5. The stator as recited in claim 1, wherein two radially adjoining layers in a slot are constituted of at least two radially adjoining, individual conductors.

6. The stator as recited in claim 1, wherein the stator is provided with concentrated windings.

7. The stator as recited in claim 1, wherein the stator is provided with distributed windings.

8. A method for determining the use and/or characteristics of the partition for a stator in a accordance with claim 1, comprising:
determining the potential differences between adjoining conductors;
determining the existing theoretical partial discharge voltage that is dependent, on one or more of the following: aging, the environment, the conductor insulation, the form of the conductor or the voltage characteristic;
using the partition if the calculated potential difference is above the theoretical partial discharge voltage; and
not using the partition if the calculated potential difference is below the theoretical partial discharge voltage.

9. The method as recited in claim 8, wherein, if the calculated potential differences exceed the theoretical partial discharge voltage, the selection of a suitable partition depends on the magnitude of the difference between the calculated potential differences and the theoretical partial discharge voltage.

10. The method as recited in claim 8, wherein, once a partial-discharge inception voltage is established, the requisite, nominal layer thickness of the insulating material between the adjoining conductors is determined;
wherein the thickness of the insulating layers of the adjoining conductors are included in the calculation of the nominal layer thickness;
wherein the necessary, local, insulating layer thickness is computed from the ratio of the potential difference of two adjoining conductors and the partial-discharge inception voltage; and
wherein the thickness of the insulating material of the two adjoining conductors is deducted from the computed insulating layer thickness to determine the thickness of the insulating material to be additionally inserted.
